(19) United States
(12) Patent Application Publication
(10) Pub. No.: US 2009/0149982 A1
(43) Pub. Date: Jun. 11, 2009

(54) Substrate processing apparatus, substrate processing method, and computer program

(76) Inventors: Makio Higashi, Kikuchi-gun (JP); Akira Miyata, Kikuchi-gun (JP); Shinichi Seki, Kikuchi-gun (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/318,815

(22) Filed: Jan. 8, 2009

Related U.S. Application Data
(62) Division of application No. 11/178,276, filed on Jul. 12, 2005.

(30) Foreign Application Priority Data
Jul. 16, 2004 (JP) JP2004-209874

(51) Int. Cl. G06F 19/00

(52) U.S. Cl. 700/110; 700/121

(57) ABSTRACT

In the present invention, when a ghost wafer which is not recognized by a control unit on a coating and developing treatment apparatus side is carried out of another apparatus which is connected to the coating and developing treatment apparatus, the ghost wafer is temporarily housed in a buffer cassette on the coating and developing treatment apparatus side. The ghost wafer in the buffer cassette is then collected into a carry-in/out section on the coating and developing treatment apparatus side through use of a carrier unit at a timing which does not affect processing of other wafers in a break between lots. According to the present invention, the ghost wafer occurred in the coating and developing treatment apparatus can be collected without suspension of processing of other ordinary substrates.

### BACKGROUND OF THE INVENTION

1. Field of the Invention

The present invention relates to a substrate processing apparatus, a substrate processing method, and a computer program.

2. Description of the Related Art

Photolithography process in a manufacturing process of, for example, a semiconductor device is usually performed using a coating and developing treatment apparatus. The coating and developing treatment apparatus includes a carry-in/out section for carrying substrates from/to the outside, a processing section including a plurality of processing and treatment units for performing various kinds of processing or treatments such as a resist coating treatment, a developing treatment, thermal processing and so on, and an interface section for transferring the substrates between the processing section and an aligner being another apparatus. The coating and developing treatment apparatus further includes a plurality of carrier units for carrying the substrates between the aforementioned sections and between the processing and treatment units.

In processing the substrates in the above-described coating and developing treatment apparatus, a plurality of substrates carried into the carry-in/out section are sequentially carried by the carrier units to the processing section and then sequentially carried into the plurality of processing and treatment units in the processing section where predetermined processing and treatments such as resist coating treatment, thermal processing, and so on are performed for each of the substrates. The substrates which have been subjected to the predetermined processing and treatment in the processing section are sequentially carried by the carrier units into the interface section, and then carried from the interface section to the aligner. The substrates which have been subjected to exposure processing in the aligner are carried out of the aligner to the interface section, and then carried from the interface section again to the processing section. The substrates in the processing section are subjected to predetermined processing and treatments such as developing treatment in the processing units and then sequentially returned to the carry-in/out section. In this coating and developing treatment apparatus, the plurality of substrates are consecutively processed lot by lot.

Besides, in the coating and developing treatment apparatus in which a plurality of substrates are consecutively processed as described above, an identification number for management is usually attached to each of the substrates to be processed, so that each substrate is managed based on the identification number during processing of the substrates (see Japanese Patent Application Laid-open No. 2004-87878).

Incidentally, since the aligner, into which the substrates are temporarily carried in a series of processing of the substrates, and the coating and developing treatment apparatus are discrete apparatuses as described above, the apparatuses include respective control systems for managing the processing and carriage of the substrates. Conventionally, when passing the substrates between the coating and developing treatment apparatus and the aligner, for example, the coating and developing treatment apparatus have sequentially carried, into the aligner, a plurality of wafers managed by their identification numbers and sequentially have received the wafers subjected to exposure and carried out, and then have managed them again.

However, a substrate not recognized on the coating and developing treatment apparatus side, a so-called “ghost wafer” may be carried out from the aligner side to the coating and developing treatment apparatus side. There are conceivable reasons for this including: for example, a substrate carried into the aligner directly by hand being carried out to the coating and developing treatment apparatus side; an operation mistake relating to a carried-out substrate occurring on the aligner side; identification data of a carried-in substrate being lost because the power of the coating and developing treatment apparatus has been turned off and then the apparatus has been restarted due to a trouble after the substrate has been carried from the coating and developing treatment apparatus side into the aligner and so on.

When the “ghost wafer” is carried out to the coating and developing treatment apparatus side as described above, the coating and developing treatment apparatus cannot receive the unrecognized “ghost wafer.” Therefore, the carriage of the substrate between the coating and developing treatment apparatus and the aligner is stopped, and resultingly the carriage and processing of all the substrates are suspended in the coating and developing treatment apparatus. The “ghost wafer” is removed by hand by an operator. The substrate processing is suspended every time the “ghost wafer” occurs and removal work of the “ghost wafer” is performed as described above, causing a significant decrease in the efficiency of producing substrates. In addition, there is a dangerous necessity for the operator to insert his or her hand and head into the apparatus to remove the “ghost wafer” by hand.

### SUMMARY OF THE INVENTION

The present invention has been developed in consideration of the above problems, and its object is to collect an unrecognized substrate such as a “ghost wafer” occurred in a substrate processing apparatus such as a coating and developing treatment apparatus without suspending processing of other ordinary substrates.

To achieve the aforementioned object, the present invention is a substrate processing apparatus including: a carry-in/out section for carrying substrates in/out; a processing section for processing the substrates; a substrate carrier means capable of carrying the substrates carried in the carry-in/out section to the processing section and from the processing section to another apparatus side, and carrying the substrates carried out of the other apparatus to the processing section and from the processing section to the carry-in/out section; and a control unit for controlling the carriage of the substrates by the substrate carrier means, the control unit controlling the carriage of each of the substrates while individually managing the substrates carried by the substrate carrier means, and if an unrecognized substrate which is not recognized by the control unit is carried out of the other apparatus, the control unit controlling carriage of the unrecognized substrate to the carry-in/out section using the substrate carrier means to collect the unrecognized substrate.

Note that the “unrecognized substrates” include not only an actually-existing substrate but also a not actually-existing substrate which means, for example, a case in which there is only a substrate carry-out signal from the other apparatus and there is no actual substrate.

The control unit may control the carriage of the unrecognized substrate to the carry-in/out section to collect the unrecognized substrate in a manner not to interfere with processing of ordinary substrates which are recognized by the control unit.

The substrate processing apparatus may further include a housing unit for housing the unrecognized substrate, wherein the control unit may control temporary housing of the unrecognized substrate carried out of the other apparatus into the housing unit using the substrate carrier means and carriage of the unrecognized substrate in the housing unit to the carry-in/out section using the substrate carrier means at a timing which does not interfere with the processing of the ordinary substrates. The substrate processing apparatus may further include a transfer section for performing transfer between the processing section and the other apparatus, wherein the substrate carrier means may carry the substrates between the processing section and the other apparatus via the transfer section, and wherein the housing unit may be provided in the transfer section.

The control unit may conduct control such that the carriage of the unrecognized substrate to the carry-in/out section is performed in a break between lots of the ordinary substrate.

The present invention according to another aspect is a substrate processing method using a substrate processing apparatus, the apparatus including: a carry-in/out section for carrying substrates in/out; a processing section for processing the substrates; a substrate carrier means capable of carrying the substrates carried in the carry-in/out section to the processing section and from the processing section to another apparatus side, and carrying the substrates carried out of the other apparatus to the processing section and from the processing section to the carry-in/out section; and a control unit for controlling the carriage of the substrates by the substrate carrier means, the method including the steps of: the control unit controlling the carriage of each of the substrates while individually managing the substrates carried by the substrate carrier means, and if an unrecognized substrate which is not recognized by the control unit is carried out of the other apparatus, carrying the unrecognized substrate to the carry-in/out section using the substrate carrier means to collect the unrecognized substrate.

The present invention according to a still another aspect is a computer program product for processing in a substrate processing apparatus, the apparatus including: a carry-in/out section for carrying substrates in/out; a processing section for processing the substrates; a substrate carrier means capable of carrying the substrates carried in the carry-in/out section to the processing section and from the processing section to another apparatus side, and carrying the substrates carried out of the other apparatus to the processing section and from the processing section to the carry-in/out section; and a control unit for controlling the carriage of the substrates, the computer program product including: computer readable program code means for causing a computer to execute processing to individually manage, using the control unit, the substrates carried by the substrate carrier means, and, if an unrecognized substrate which is not recognized by the control unit is carried out of the other apparatus, to carry the unrecognized substrate to the carry-in/out section using the substrate carrier means to collect the unrecognized substrate.

According to the present invention, even when an unrecognized substrate occurs, there is no need to suspend processing of other substrates, so that the efficiency of producing substrates in the substrate processing apparatus can be improved.

### BRIEF DESCRIPTION OF THE DRAWINGS

FIG. 1 is a plan view showing the outline of a coating and developing treatment apparatus according to this embodiment;

FIG. 2 is a front view of the coating and developing treatment apparatus in FIG. 1;

FIG. 3 is a rear view of the coating and developing treatment apparatus in FIG. 1;

FIG. 4 is an explanatory diagram showing an example of a carriage flow of a wafer;

FIG. 5 is an explanatory diagram showing an example of a carriage schedule for a wafer;

FIG. 6 is a flowchart showing a collection process of a ghost wafer; and

FIG. 7 is an explanatory diagram showing an example of a collection schedule for a ghost wafer.

### DETAILED DESCRIPTION OF THE INVENTION

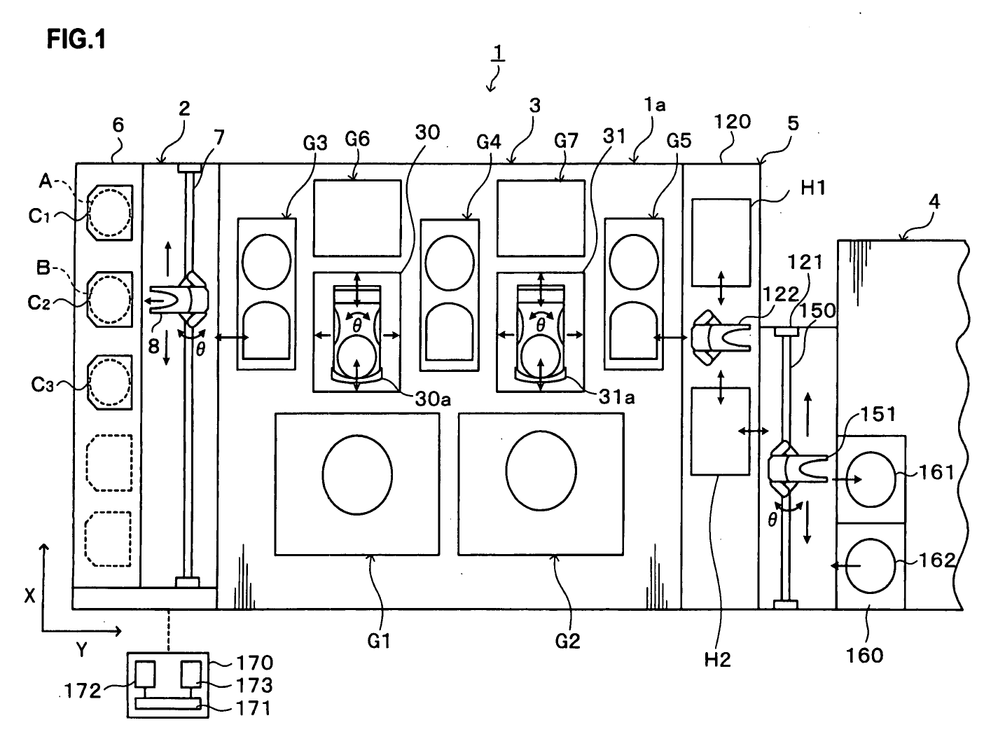

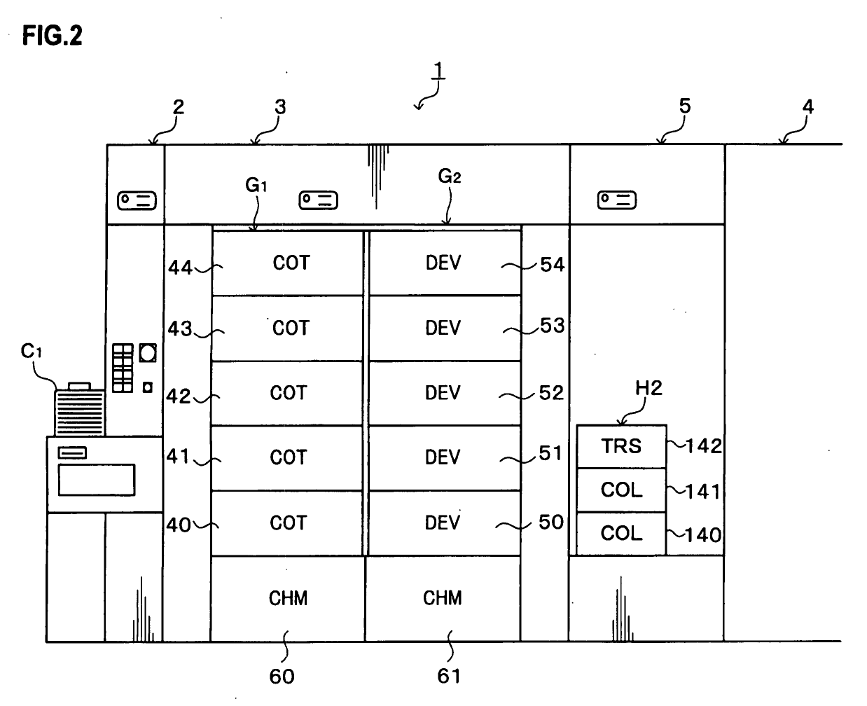

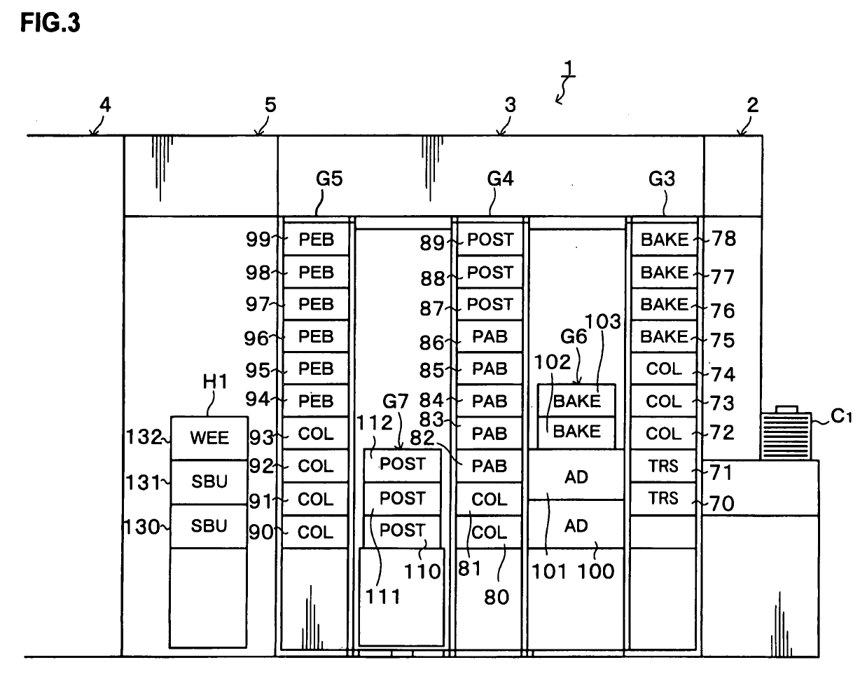

Hereinafter, a preferred embodiment of the present invention will be described. FIG. 1 is a plan view showing the outline of a configuration of a coating and developing treatment apparatus 1 as a substrate processing apparatus according to this embodiment, FIG. 2 is a front view of the coating and developing treatment apparatus 1, and FIG. 3 is a rear view of the coating and developing treatment apparatus 1.

The coating and developing treatment apparatus 1 has, as shown in FIG. 1, a configuration, in a casing 1a as a housing covering the entire apparatus, for example, a cassette station 2 as a carry-in/out section for carrying, for example, 25 wafers per cassette from/to the outside into/from the coating and developing treatment apparatus 1 and carrying the wafers into/out of the cassette C, a processing station 3 as a processing section including various kinds of processing and treatment units, which are multi-tiered, for performing predetermined processing or treatments in a manner of single wafer processing in coating and developing treatment processes, and an interface section 5 as a transfer unit for transferring the wafers to/from an aligner 4 as another apparatus provided adjacent to the processing station 3, are connected together.

In the cassette station 2, a plurality of cassettes, for example, cassettes C1, C2, and C3 can be mounted at predetermined positions on a cassette mounting table 6 in a line in an X-direction (a top-to-bottom direction in FIG. 1). In the cassette station 2, a wafer carrier unit 8 is provided which is movable in the X-direction on a carrier path 7. The wafer carrier unit 8 is movable also in the vertical direction and thus can selectively access the wafers arranged in the vertical direction in the cassette. The wafer carrier unit 8 is rotatable around an axis in the vertical direction (a θ-direction) and thus can also access later-described units in a third processing unit group G3 on the processing station 3 side.

The processing station 3 comprises, as shown in FIG. 1, for example, seven processing unit groups G1 to G7 in each of which a plurality of processing and treatment units are multi-tiered. On the side of the negative direction in the X-direction (the lower side in FIG. 1) being the front side in the processing station 3, the first processing unit group G1 and the second processing unit group G2 are placed in order from the cassette station 2 side. At the center portion of the processing station 3, the third processing unit group G3, the fourth processing unit group G4, and the fifth processing unit group G5 are placed in order from the cassette station 2 side. On the side of the positive direction in the X-direction (the upper side in FIG. 1) being the rear side in the processing station 3, the sixth processing unit group G6 and the seventh processing unit group G7 are placed in order from the cassette station 2 side.

Between the third processing unit group G3 and the fourth processing unit group G4, a first carrier unit 30 is provided. The first carrier unit 30 has a carrier arm 30a which is, for example, rotatable in the θ-direction and movable in the horizontal direction and in the vertical direction. The first carrier unit 30 can move back and forth the carrier arm 30a with respect to the units in the adjacent first processing unit group G1, third processing unit group G3, fourth processing unit group G4, and sixth processing unit group G6, thereby carrying the wafer among the units in the processing unit groups G1, G3, G4, and G6.

Between the fourth processing unit group G4 and the fifth processing unit group G5, a second carrier unit 31 is provided. The second carrier unit 31 has, similarly to the first carrier unit 30, a carrier arm 31a which can selectively access the units in the second processing unit group G2, the fourth processing unit group G4, the fifth processing unit group G5, and the seventh processing unit group G7 to carry the wafer to them.

As shown in FIG. 2, in the first processing unit group G1, solution treatment units each for supplying a predetermined solution onto the wafer to thereby perform treatment, for example, resist coating units 40 to 44 each for applying a resist solution onto the wafer to form a resist film are five-tiered in order from the bottom. In the second processing unit group G2, solution treatment units, for example, developing units 50 to 54 each for performing developing treatment for the wafer are five-tiered in order from the bottom. Further, chemical chambers 60 and 61 each for supplying various kinds of treatment solutions to the solution treatment units in the processing unit groups G1 and G2 are provided at the lowermost tiers of the first processing unit group G1 and the second processing unit group G2, respectively.

As shown in FIG. 3, in the third processing unit group G3, for example, transition units 70 and 71 for passing the wafer, cooling units 72 to 74 for cooling the wafer under high-precision temperature control, and high-temperature thermal processing units 75 to 78 each for performing heating processing for the wafer at a high temperature, are nine-tiered in order from the bottom.

In the fourth processing unit group G4, for example, cooling units 80 and 81, pre-baking units 82 to 86 each for performing heating processing for the wafer after the resist coating treatment, and post-baking units 87 to 89 each for performing heating processing for the wafer after the developing treatment are ten-tiered in order from the bottom.

In the fifth processing unit group G5, for example, cooling units 90 to 93 and post-exposure baking units 94 to 99 as thermal processing units each for performing heating processing for the wafer after exposure, are ten-tiered in order form the bottom. The post-exposure baking units 94 to 99, each having in a container a heating plate on which the wafer is mounted and heated and a cooling plate on which the wafer is mounted and cooled, can perform both heating and cooling the wafer.

In the sixth processing unit group G6, as shown in FIG. 3, for example, adhesion units 100 and 101 each for performing hydrophobic treatment on the wafer and heating processing units 102 and 103 each for performing heating processing for the wafer are four-tiered in order from the bottom. In the seventh processing unit group G7, as shown in FIG. 3, for example, post-baking units 110 to 112 are three-tiered in order from the bottom.

In the interface section 5, as shown in FIG. 1, for example, a first interface section 120 and a second interface section 121 are provided in order from the processing station 3 side. In the first interface section 120, for example, a first wafer carrier unit 122 is provided at a position opposed to the fifth processing unit group G5. On both sides in the X-direction of the first wafer carrier unit 122, for example, two unit groups H1 and H2 are arranged.

For example, in the unit group H1 on the side of the positive direction in the X-direction, as shown in FIG. 3, buffer cassette units 130 and 131 as housing units and an edge exposure unit 132 for selectively exposing only the outer peripheral portion of the wafer are arranged in order from the bottom. In the unit group H2 on the side of the negative direction in the X-direction, as shown in FIG. 2, for example, cooling units 140 and 141 and a transition unit 142 are arranged in order from the bottom.

As shown in FIG. 1, the first wafer carrier unit 122 is movable in the horizontal direction and in the vertical direction and rotatable in the θ-direction and thus can access the units in the fifth processing unit group G5, the unit group H1 and the unit group H2.

In the second interface section 121, a second wafer carrier unit 151 is provided which moves on a carrier path 150 directed, for example, in the X-direction. The second wafer carrier unit 151 is movable in the Z-direction and also rotatable in the θ-direction and thus can carry the wafer, for example, between the unit in the unit group H2 and a later-described transfer table 160 in the aligner 4.

In the aligner 4, for example, the transfer table 160 is provided for transferring the wafer to/from the second wafer carrier unit 151 in the interface section 5. On the transfer table 160, a carry-in mounting portion 161 and a carry-out mounting portion 162 on each of which the wafer can be mounted are arranged side by side. The second wafer carrier unit 151 can mount the wafer in the unit group H2 onto the carry-in mounting portion 161, and the aligner 4 can receive the wafer mounted on the carry-in mounting portion 161 and perform exposure processing for the wafer. The aligner 4 can mount the wafer for which exposure processing has been completed onto the carry-out mounting portion 162, and the second wafer carrier unit 151 can receive the wafer mounted on the carry-out mounting portion 162 and carry it into the unit group H2.

Note that, in this embodiment, the wafer carrier unit 8, the first carrier unit 30, the second carrier unit 31, the first wafer carrier unit 122, and the second wafer carrier unit 151 constitute a substrate carrier means.

Management of the wafer processing and wafer carriage in the coating and developing treatment apparatus 1 is performed, for example, by a control unit 170 shown in FIG. 1. In the control unit 170, for example, a carriage flow for performing predetermined processing for the wafer is set for each lot. The control unit 170 can sequentially carry the wafers in each lot in accordance with the carriage flow by controlling the actions of the carrier units 7, 30, 31, 122, and 155 in the coating and developing treatment apparatus 1, thereby performing predetermined processing for each wafer. The control unit 170 performs the management, for example, with an identification number attached to each wafer carried in accordance with the carriage flow. Accordingly, the wafers in processing in the coating and developing treatment apparatus 1 are recognized by the control unit 170 at all times.

The coating and developing treatment apparatus 1 having the above-described configuration is controlled by the control unit 170. The control unit 170 has a central processing unit 171, a support circuit 172, and a storage medium 173 containing associated control software. The control unit 170 performs management of, for example, actions of the units in the coating and developing treatment apparatus 1 as well as the above-described actions of the carrier units 7, 30, 31, 122, and 155 and so on.

For the central processing unit 171 of the control unit 170, a processor for a general-purpose computer can be employed. For the storage medium 173, various types of storage media, for example, including a RAM, a ROM, a flexible disk, and a hard disk can be employed. The support circuit 174 is connected to the central processing unit 171 in order to support the processor in various ways.

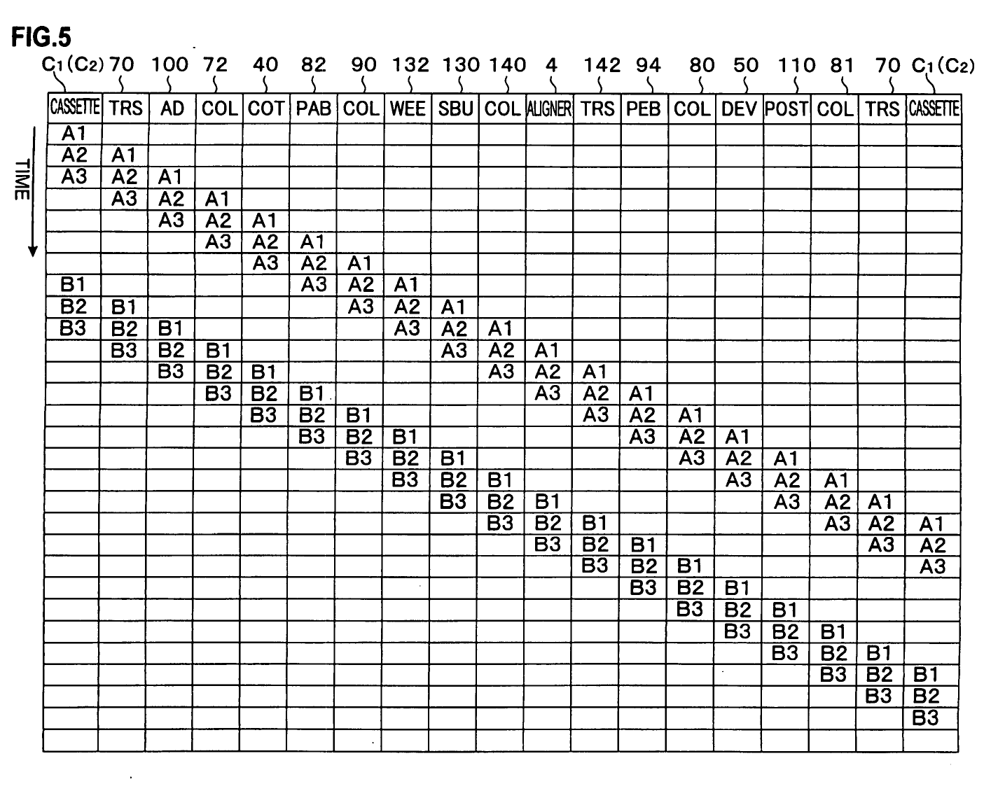

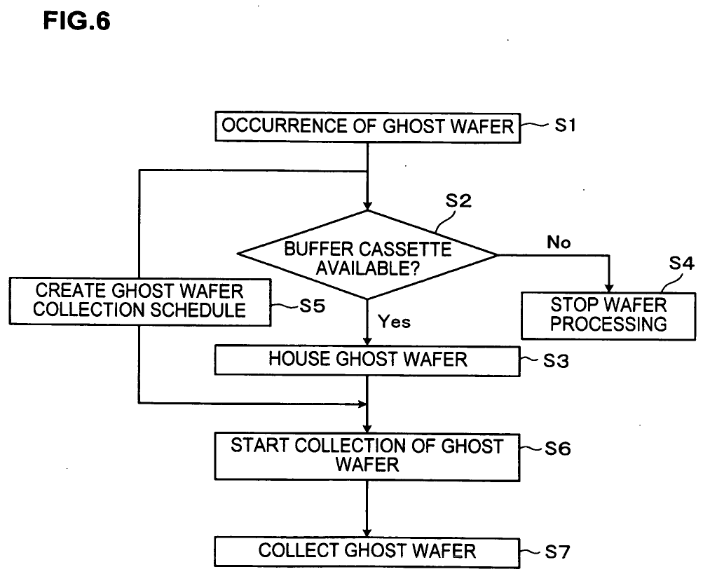

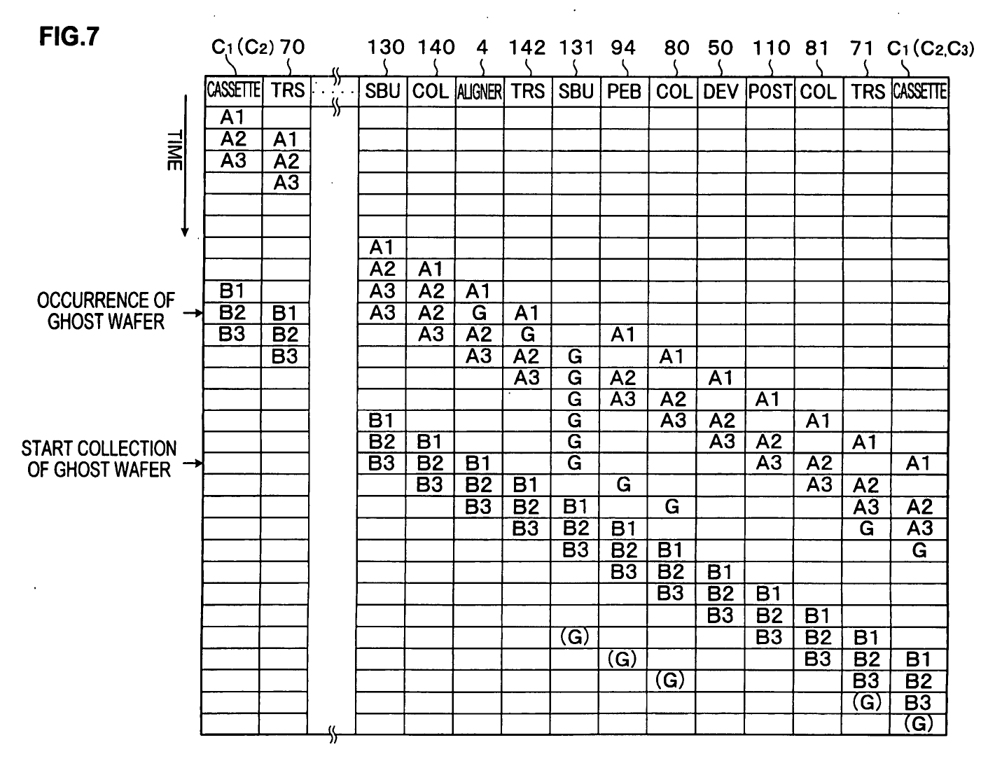

The storage medium 173 stores, for example, a computer program for control based on the flow shown in FIG. 6 as described later, schedules shown in FIG. 5 and FIG. 7, and other control programs required for carrying out the substrate processing method of the present invention, in addition to the control programs for ordinary control of the actions of the carrier units 7, 30, 31, 122, 151, and so on.

When the wafers are carried in/out between the coating and developing treatment apparatus 1 and the aligner 4 which are discrete apparatuses, the control unit 170, for example, recognizes the identification numbers and carriage order of the wafers to be carried into the aligner 4 so that the control unit 170 can recognize the identification numbers of the wafers carried out of the aligner 4 based on the order of the wafers and thus continuously manage the wafers.

Incidentally, a wafer as an unrecognized substrate which is not recognized by the control unit 170 (hereinafter, referred to as a “ghost wafer G”) may sometimes be carried out from the aligner 4 into the coating and developing treatment apparatus 1. A ghost wafer collection function for collecting the ghost wafer G into a predetermined cassette in the cassette station 2 is installed in the control unit 170. The control unit 170 can temporarily house, in the buffer cassette 131 or 131, for example, the ghost wafer G mounted on the carry-out mounting portion 162 of the aligner 4 through use of the ghost wafer collection function and keep it waiting there, and then carry the wafer to the cassette in the cassette station 2 at a predetermined timing which does not interfere with processing of other wafers.

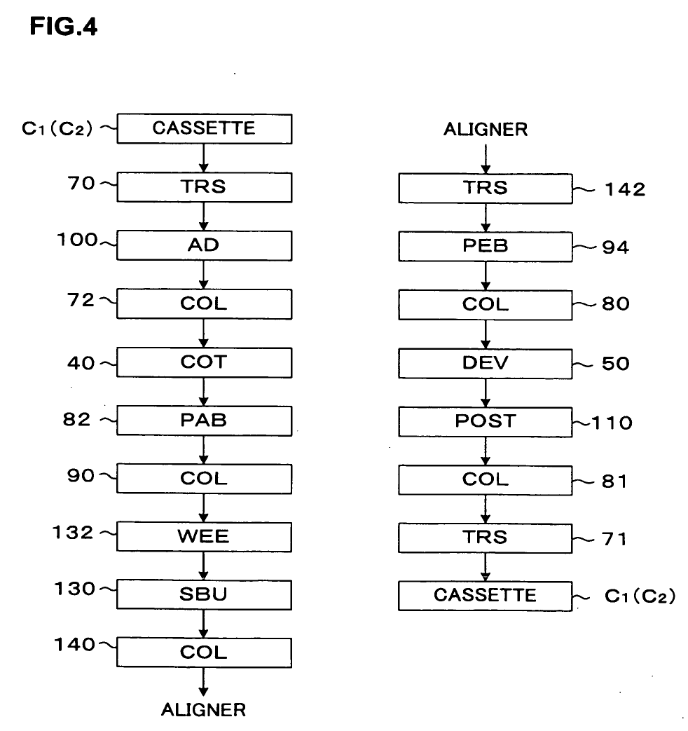

One example of ordinary wafer processing to be performed in the coating and developing treatment apparatus 1 will be explained. FIG. 4 shows an example of carriage flow of a wafer during the processing. FIG. 5 shows an example of carriage schedules for two lots.

For example, in cassettes C1 and C2 shown in FIG. 1, unprocessed wafers A to A3 and B1 to B3 in lots A and B are housed respectively. When the cassettes C1 and C2 are mounted on the mounting table 6 in the cassette station 2, the wafers A1 to A3 and B1 to B3 in the cassettes C1 and C2 are sequentially carried and processed in accordance with the carriage flow set for each lot.

For example, the wafer A1 in the lot A taken out of the cassette C1 shown in FIG. 1 is first carried by the wafer carrier unit 8 into the transition unit 70 in the third processing unit group G3. The wafer A1 carried into the transition unit 70 is carried by the first carrier unit 30 to the adhesion unit 100 in the sixth processing unit group G6, where, for example, HMDS is applied onto the wafer A1 to enhance adhesion between the wafer A1 and a resist solution. The wafer A1 is subsequently carried by the first carrier unit 30 to the cooling unit 72 in the third processing unit group G3 and cooled there, and then carried by the first carrier unit 30 to the resist coating unit 40 in the first processing unit group G1 and subjected to resist coating treatment there.

The wafer A1 which has been subjected to the resist coating treatment is carried by the first carrier unit 30 to the pre-baking units 82 in the fourth processing unit group G4 and heated and dried there, and then carried by the second carrier unit 31 to the cooling unit 90 in the fifth processing unit group G5 and cooled there. Thereafter, the wafer A1 is carried by the first wafer carrier unit 122 in the first interface section 121 to the edge exposure unit 132 in the unit group H1 and subjected to edge exposure processing there, and then housed in the buffer cassette unit 130. Thereafter, the wafer A1 is carried by the wafer carrier unit 122 to the cooling unit 140 in the unit group H2, and then mounted by the second wafer carrier unit 151 in the second interface section 121 onto the carry-in mounting portion 161 in the aligner 4.

The wafer A1 mounted on the carry-out mounting portion 162 of the aligner 4 after the exposure processing has been completed in the aligner 4 is carried by the second wafer carrier unit 151 to the transition unit 142 in the first interface section 120, and then carried by the first wafer carrier unit 122 to the post-exposure baking unit 94 in the fifth processing unit group G5. The wafer A1 heated in the post-exposure baking unit 94 is carried by the second carrier unit 31 to the cooling unit 80 in the fourth processing unit group G4 and cooled there, and then carried to the developing unit 50 in the second processing unit group G2 and developed there.

The wafer A1 for which the developing treatment has been completed is carried by the second carrier unit 31 to the post-baking unit 110 in the seventh processing unit group G7 and subjected to heating processing there, and then carried to the cooling unit 81 in the fourth processing unit group G4 and cooled there. Thereafter, the wafer A1 is carried by the first carrier unit 30 to the transition unit 71 in the third processing unit group G3, and subsequently returned by the wafer carrier unit 8 into the cassette C1 in the cassette station 2. In this way, a series of wafer processing in the coating and developing treatment apparatus 1 is completed.

In the coating and developing treatment apparatus 1, the wafers A1, A2, and A3 in the lot A are consecutively processed as shown in FIG. 5. After all of the wafers A1 to A3 in the lot A are carried out, the various kinds of processing settings in the coating and developing treatment apparatus 1 are changed to those for the lot B, and then the wafers B1 to B3 in the lot B are sequentially carried out of the cassette C2 and consecutively processed similarly to the above-described wafers in the lot A.

Next, a collection process for the ghost wafer G to be performed by the ghost wafer collection function in the control unit 170 will be explained. FIG. 6 is a flowchart of the collection process for the ghost wafer G. FIG. 7 shows the collection schedule for the ghost wafer G and the carriage schedules for the lot A and the lot B.

As shown in FIG. 7, for example, upon occurrence of the ghost wafer G in which the ghost wafer G not recognized by the control unit 170 is mounted on the carry-out mounting portion 162 in the aligner 4, after the wafer A1 in the lot A is carried out of the aligner 4 and before the wafer A2 is carried into the aligner 4 (Step S1 in FIG. 6), the control unit 170 first checks the availability of, for example, the buffer cassettes 130 and 131 in the unit group H1 (Step S2 in FIG. 6). If the buffer cassettes 130 and 131 are available, the ghost wafer G is carried, as shown in FIG. 7, by the second wafer carrier unit 151 to the transition unit 142 and carried by the first wafer carrier unit 122 to, for example, the buffer cassette 131 and housed therein (Step S3 in FIG. 6). If the buffer cassettes 130 and 131 are not available, the control unit 170 gives a ghost wafer uncollectibility alarm, whereby the wafer processing performed in the coating and developing treatment apparatus 1 is stopped (Step S4 in FIG. 6).

Upon occurrence of the ghost wafer G, the control unit 170 also creates a collection schedule for the ghost wafer G (Step S5 in FIG. 6). The carriage flow for the ghost wafer G in this event is created such that the ordinary carriage flow for the lot A or B is bypassed. For example, the carriage flow for the ghost wafer G is set such that the ghost wafer G is carried to the cassettes station 2 in the shortest period of time and in the shortest distance, for example, carried from the buffer cassette 131 to the cassette C3 through the post-exposure baking unit 94 in the fifth processing unit group G5, the cooling unit 80 in the fourth processing unit group G4, and the transition unit 71 in the third processing unit group G3.

Besides, the timing for starting the collection of the ghost wafer G is set such that its carriage is performed in a break between the lot A and the lot B so as not to interfere with the wafer processing of the previous and subsequent lots A and B. The timing for starting the collection of the ghost wafer G is determined such that the collection begins after all of the wafers A1 to A3 in the lot A have been carried out of the aligner 4 and the ghost wafer G never reaches the rearmost wafer A3 in the lot A during the collection. In this case, the timing for starting the collection may be determined by assuming that the ghost wafer G arrives at the cassette C3 immediately after the wafer A3 is returned into the cassette C1 as shown in FIG. 7, and counting backward from the arrival time of the ghost wafer G.

When the period of the break between the lot A and the lot B is short so that the timing for starting the collection satisfying the above-described condition is not found between the lot A and the lot B, the timing for starting the collection of the ghost wafer G is determined such that the collection begins, for example, after the lot B. The timing in this case is also determined such that the collection begins in a break between the lot B and a subsequent lot and the ghost wafer G never reaches the rearmost wafer B3 in the lot B during the collection (shown by (G) in FIG. 7). Note that when the timing for starting the collection satisfying the above-described condition is not found between the lot A and the lot B, it is also possible to intentionally take much time to carry the ghost wafer G to retard the carriage so as to prevent the ghost wafer G from reaching the wafer A3. In this case, it is also possible to increase the number of units through which the ghost wafer G passes.

Then, at the timing for starting the collection of the ghost wafer G, collection of the ghost wafer G by the carrier units is started (Step S6 in FIG. 6), whereby the ghost wafer G housed in the buffer cassette 131 is collected in accordance with the above-described carriage flow, into the cassette C3 for ghost wafers separated from the ordinary wafers in the cassette station 2, for example, through the post-exposure baking unit 94, the cooling unit 80, and the transition unit 71 (Step S7 in FIG. 7).

According to the above embodiment, it is possible to automatically collect the ghost wafer G occurred when a wafer is transferred between the aligner 4 and the coating and developing treatment apparatus 1, into the cassette station 2 using the carrier units, thus avoiding the necessity to suspend the wafer processing and perform recovery work every time the ghost wafer G occurs, as in the prior art, resulting in an improved efficiency of producing wafers in the coating and developing treatment apparatus 1. In addition, it is not necessary for an operator to remove the ghost wafer G by hand by an operator, avoiding a danger involved in the work.

Further, since the ghost wafer G is temporarily housed in the buffer cassette 131 and carried to the cassette station 2 in the break between the lot A and the lot B, the ghost wafer G can be collected without interference with the processing flow of the ordinary wafers.

Since the buffer cassettes 130 and 131 for housing the ghost wafer G are provided in the interface section 5 close to the aligner 4, it is possible to immediately house the ghost wafer G occurred in the aligner 4 into the buffer cassette 131, thereby minimizing the influence on the processing flow of the ordinary wafers.

According to the above embodiment, the ghost wafer G is collected after being carried in sequence through the processing unit groups G5, G4, and G3 which are linearly arranged in the direction from the interface section in which the buffer cassette 131 is located to the cassette station 2 side, so that the collection of the ghost wafer G can be performed in a short time. Although the ghost wafer G passes through the post-exposure baking unit 94 in the fifth processing unit group G5, the cooling unit 80 in the fourth processing unit group G4, and the transition unit 71 in the third processing unit group G3 in the above-described embodiment, the ghost wafer G may pass through other units in the processing unit groups G3 to G5. Alternatively, the ghost wafer G may pass through units which are not in use for the carriage flow of the lot A and the lot B which have been in processing before and after the occurrence of the ghost wafer G.

While the ghost wafer G is housed in the buffer cassette 131 in the unit group H1 in the above embodiment, a buffer cassette may be provided in another unit group, for example, in the unit group H2 so that the ghost wafer G may be housed in that buffer cassette. Alternatively, the buffer cassette for housing the ghost wafer G may be provided in the processing station 3. The buffer cassette may be one for also housing ordinary wafers or one exclusive to the ghost Wafer G. In the case of the exclusive buffer cassette, unavailability of the buffer cassette upon occurrence of the ghost wafer G can be avoided.

Note that, in the above-described embodiment, even if the buffer cassettes 130 and 131 are unavailable upon occurrence of the ghost wafer G, the processing of wafers housed in the buffer cassettes 130 and 131 may be continued so as to keep the period fixed from the exposure processing to the developing treatment for the wafer. This allows an appropriate pattern to be formed also on the wafers which have been housed in the buffer cassettes 130 and 131 at the time of occurrence of the ghost wafer G, preventing those wafers from being wasted. Further, in this example, the host wafer G may be carried in a manner to follow the wafers carried from the buffer cassettes 130 and 131 and processed, and then collected into the cassette C. In this case, the ghost wafer G may be collected by being carried directly to the processing station 3 side without being temporarily housed in the buffer cassette 130 or 131.

As in the case in which the aligner 4 performs carriage action even though there is no actual wafer, the ghost wafer G may sometimes not be an actually existing wafer. For example, a sensor for detecting an actual wafer may be attached to the carry-out mounting portion 162 in the aligner 4, so that upon occurrence of the ghost wafer G, the sensor detects whether there is an actual wafer or not. If there is no actual wafer, the ordinary wafer processing may be continued ignoring the occurrence of the ghost wafer G. Note that the sensor for detecting an actual wafer may be attached, for example, to the arm of the second wafer carrier unit 151 so that the arm may be moved to a position above the carry-out mounting portion 162 to try to hold an actual wafer, thereby detecting the presence or absence of the actual wafer.

Though one example of the embodiment of the present invention has been described in the above, the present invention is not limited to this example but can take various forms. For example, the transfer table 160 is provided on the aligner 4 side in this embodiment, but the present invention is also applicable to a form in which the transfer table is provided on the coating and developing treatment apparatus 1 side. Further, the kinds, the number and the arrangement of the carrier units and processing units to be installed in the coating and developing treatment apparatus 1 described in this embodiment are not limited to those. Besides, the present invention is applicable not only to the coating and developing treatment apparatus 1 but also, for example, to other substrate processing apparatuses such as an etching apparatus, a film forming apparatus, and a cleaning apparatus. Further, the aforementioned other apparatus is not limited to the aligner 4. Furthermore, the present invention is also applicable to processing apparatuses not only for the semiconductor wafer but also for other substrates such as an FPD (flat panel display) substrate, a glass substrate for photomask, and so on.

The present invention is useful in collecting an unrecognized substrate occurred in the apparatus without suspension of processing of other ordinary substrates.

1-5. (canceled)

6. A substrate processing method using a substrate processing apparatus, said apparatus comprising: a carry-in/out section for carrying substrates in/out; a processing section for processing the substrates; a substrate carrier means capable of carrying the substrates carried in the carry-in/out section to the processing section and from the processing section toward another apparatus side, and carrying the substrates carried out of the other apparatus to the processing section and from the processing section to the carry-in/out section; and a control unit for controlling the carriage of the substrates by the substrate carrier means, said method comprising the steps of:
controlling by the control unit, the carriage of each of the substrates while individually managing the substrates carried by the substrate carrier means, and
if an unrecognized substrate which is not recognized by the control unit is carried out of the other apparatus, carrying the unrecognized substrate to the carry-in/out section using the substrate carrier means to collect the unrecognized substrate.

7. The substrate processing method as set forth in claim 6, wherein
the unrecognized substrate is carried to the carry-in/out section to be collected in a manner not to affect processing of ordinary substrates which are recognized by the control unit.

8. The substrate processing method as set forth in claim 7, wherein
the unrecognized substrate from the other apparatus is temporarily housed into a housing unit using the substrate carrier means, and the unrecognized substrate in the housing unit is carried to the carry-in/out section using the substrate carrier means at a timing which does not affect the processing of the ordinary substrates.

9. The substrate processing method as set forth in claim 6, wherein the carriage of the unrecognized substrate to the carry-in/out section is performed in a break between lots of the ordinary substrates.

10-13. (canceled)

14. The substrate processing method as set forth in claim 6, wherein
said substrate processing apparatus further comprises a sensor for detecting the presence or absence of an actual substrate,
wherein when the unrecognized substrate occurs in said other apparatus, said sensor detects the pressure or absence of an actual substrate, and
wherein when no actual substrate is detected by said sensor, said control unit ignores the occurrence of the unrecognized substrate and continues the processing of ordinary substrates.
